(19) United States
(12) Patent Application Publication
(10) Pub. No.: US 2019/0056617 A1
(43) Pub. Date: Feb. 21, 2019

(54) FLEXIBLE HEATER FOR FLAT PANEL DISPLAY DEVICE

(71) Applicant: ThermoSoft International Corporation, Vernon Hills, IL (US)

(72) Inventor: Eric KOCHMAN, Vernon Hills, IL (US)

(21) Appl. No.: 16/101,700

(22) Filed: Aug. 13, 2018

Related U.S. Application Data
(60) Provisional application No. 62/546,347, filed on Aug. 16, 2017.

(51) Int. Cl. G02F 1/1333

(52) U.S. Cl. CPC G02F 1/133382; G02F 1/133305; G02F 1/133308

(57) ABSTRACT

The flexible removable heater is placed behind and/or attached around the perimeter of the flat panel display device for freeze protection and ease of installation of the heater in the field. The flexible heater is connected to a temperature control device which energizes the heater at ambient temperatures below 5° C. The flexible heater may be connected to an optional overheat protection temperature control device which is attached to or placed inside of the flat panel display device.

### CROSS-REFERENCE TO RELATED APPLICATIONS

The present application claims priority of U.S. provisional application 62/546,347 filed on Aug. 16, 2017, which is incorporated herein by reference

### SPECIFICATION

### Field of the Invention

The present invention is in the technical field of flexible heaters and flat panel display devices. More particularly, the present invention is in the technical field of heating electronic devices, incorporating Liquid Crystal Displays (LCD) or Light-Emitting Diode (LED) displays, and methods of protection the displays from freezing, misting and malfunction.

### BACKGROUND OF THE INVENTION

In today's world, the key problems of electronic displays, especially the ones with touchscreen capabilities and operating at temperatures below 5° C. (41° F.), is freezing, misting and malfunction of the displays. The attempts to resolve this problem by heating the space between the LCD and printing circuit board (PCB) assembly was described in U.S. Pat. No. 6,163,359, Smith at al., Dec. 19, 2000. The drawback of this solution is dependence on permanent installation of internal heater, lack of removability and insufficient space to insulate the heater to effectively reflect warmth towards the LCD. Another attempt of preventing the freezing of LCD is described in U.S. Pat. No. 8,009,262 B2, Dunn, Aug. 30, 2011. The drawback of this solution is absence of heat insulation which causes substantial heat dissipation from the transparent heater placed in front of the LCD.

### SUMMARY OF THE INVENTION

The present invention is an insulated flexible heater which is placed behind and in close proximity to the flat panel display device to prevent freezing and/or misting of the display at low ambient temperatures. The proposed heater is positioned either behind the flat panel display device and/or wraps the LCD (or LED) display device around its perimeter. Alternatively, the proposed flexible heater is attached to the electrical junction box or junction box cover allowing the heater to be positioned behind the flat panel display device. The heater is removable to allow its installation or replacement in the field and electrically connected to temperature control device to prevent freezing and, optionally, to prevent overheating of the flat panel displays. The freeze protection temperature control device is installed outside of the flexible heater to control the ambient temperature and to energize the flexible heater at the temperatures below 5° C. Alternatively, the freeze protection temperature control device or overheat protection control device are installed inside of the flat panel display device. The method of assembly and electrical connection between the flexible heater and the flat panel display device is described.

### BRIEF DESCRIPTION OF THE DRAWINGS

FIG. 1 is a side view of the electrical junction box and electrical junction box cover showing cross section of flexible heater of the present invention.

FIG. 2(a) is a front view of the electrical junction box cover showing a heater and freeze protection temperature control means of the present invention.

FIG. 2(b) is a back view of the electrical junction box cover showing a heater and freeze protection temperature control means of the present invention.

FIG. 3 is a cross section of the flat electrical junction box cover and heater of the present invention.

FIG. 4(a) is a schematic diagram of the flat panel display device and flexible heater of the present invention.

FIG. 4(b) is a schematic diagram of the electrical connection of the flat panel display device and flexible heater of the present invention.

FIG. 4(c) is a schematic diagram of the electrical connection of the flat panel display device and the flexible heater of the present invention.

FIG. 4(d) is a schematic diagram of the electrical connection of the flat panel display device and flexible heater of the present invention.

FIG. 5(a) is an isometric view of the heater and flat panel display device with the cross section showing the freeze protection temperature control means of the present invention.

FIG. 5(b) is an isometric view of the heater and electrical junction box assembly means, flat panel display device having the cross section and showing the freeze protection temperature control means and overheat protection means of the present invention.

FIG. 6 is a cross section of the flat panel display device and flexible heater of the present invention.

FIG. 7 is an isometric view of the flexible heater of present Invention.

FIG. 8 is a cross section of the flat panel display device and flexible heater of the present invention.

### DETAILED DESCRIPTION OF THE INVENTION

The invention consists of the flexible electrical heater placed at least behind of the electronic display means, said heater provides warming of said electronic display means in a freezing outdoor environment utilizing ambient freeze protection temperature control means and optional overheat protection means.

The term “electronic display means” or “flat panel display device” or “electronic display device” described in this invention shall mean any security entrance device containing flat panel LCD or LED display, security entrance keypad panel, or any other electronic device having front panel display and whose performance is affected by the outdoor temperatures below 5° C.

The term “heating blanket” described in this invention shall mean a flexible heating panel or mat, comprising at least one electrical heating element which is spread through and attached to the surface of said flexible panel or mat. The flexible heating blanket is energized by direct or alternating currents. It is preferable that the flexible heating blanket is energized by a low voltage.

The term “insulation means” or “insulation member” described in this invention shall mean at least one layer of temperature resistant insulating material such as polymer foam or rubber designed to preserve and reflect heat, generated by said electrical heating blanket. The insulation means may comprise at least one heat reflection layer, for example metal foil.

The term “flexible heater” described in this invention shall mean an electrical heating device comprising said electrical flexible heating blanket, said insulation means, optional holding means such as adhesive or fastener, lead wires and temperature control devices, such as thermostats or thermal sensor with electronic temperature control.

The term “junction box assembly means” or “junction box assembly” described in this invention shall mean a combination of wall electrical junction box and its front junction box cover.

The term “junction box cover” described in this invention shall mean the front metal or plastic cover of the junction box assembly means.

The term “freeze protection temperature control means” or “temperature control means” or “freeze protection apparatus” described in this invention shall mean any electric temperature sensing device to control the ambient temperature and to prevent said electronic display means from freezing, misting and malfunction. Said temperature control means may comprise a bi-metal thermostat, thermal sensor which is connected to an electronic temperature control device or any other electronic device which activates electrical continuity in said electrical flexible heating blanket at the temperatures below 5° C.

The term “overheat protection means” or “overheat protection mechanism” described in this invention shall mean any electric temperature sensing device to control the temperature inside of said electronic display means and prevent the electronic devices from overheating and malfunction. Said overheat protection means may comprise bi-metal thermostat, thermal sensor which is connected to an electronic temperature control device or any other electronic device which terminates electrical continuity in said electrical flexible heating blanket at the temperatures above 32° C.

The term “conductor opening means” described in this invention shall mean any hole, opening or cutout in said flexible heating blanket to allow penetration of electrical wiring through the body of said heating blanket.

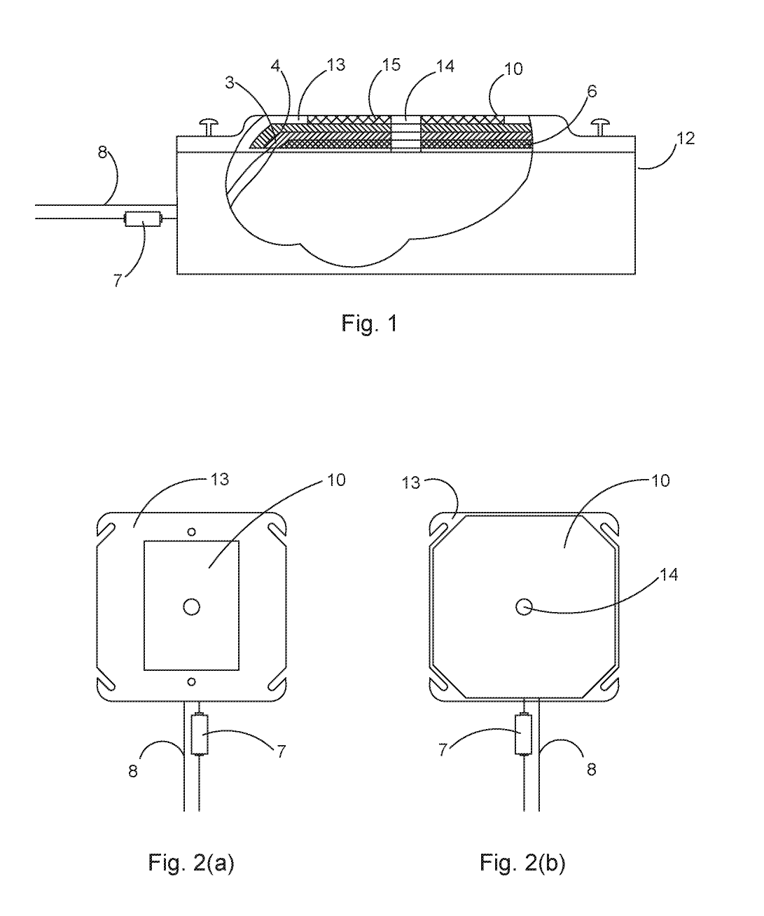

Referring now to the invention in more detail, in FIG. 1 there is shown a side view of the wall electrical junction box assembly means 12 with a removable heater 10 attached to the back of the junction box cover 13. The removable heater 10 comprises insulation means 6, which is placed on the back of the flexible heating blanket 3 to reflect heat towards the box cover 13. It is preferable that the insulation means 6 comprises a heat reflection layer, for example a metal foil. The holding means 4, which can be a temperature resistant adhesive or fastener, provides secure attachment of the flexible heating blanket 3 to the back of the electrical box cover 13. The optional front cover 15 of the heating blanket 3 provides mechanical protection and heat sink function if the cover 15 comprises metal, for example aluminum foil.

In further detail, the flexible heating blanket 3 can be positioned at any part of the wall electrical junction box assembly means as long as it can provide heat towards the electronic display means.

In further detail, in FIG. 1 there is shown a flexible heater 10 having the temperature control means 7 to control the ambient temperature and to prevent the electronic devices from freezing, misting and malfunction. The freeze protection temperature control means 7 is distanced away from the heater 10 to measure the outside ambient temperature or the working temperature of the flat panel display. The temperature control means 7 is connected with electrical heating blanket 3 through the lead wires 8. The construction detail of the invention, as shown in FIG. 1 is that the flexible heater 10 follows the contour of the curved electrical box cover 13 to allow positioning of the heater 10 in a close proximity to the electronic devices, thus maximizing heat exchange and efficiency of the flexible heater 10.

The heater 10 as shown in FIG. 1 has a conductor opening 14 to allow electric wiring from the junction electrical box 13 to the electronic display means. Referring now to the invention in more detail, there is shown a front view in FIG. 2(a) and the back view in FIG. 2(b) of the electrical junction box cover 13 with the heater 10 attached to it. The heater 10 comprises a temperature control means 7 and lead wiring 8 so that the whole assembly may be connected to an independent power source such as a step-down transformer.

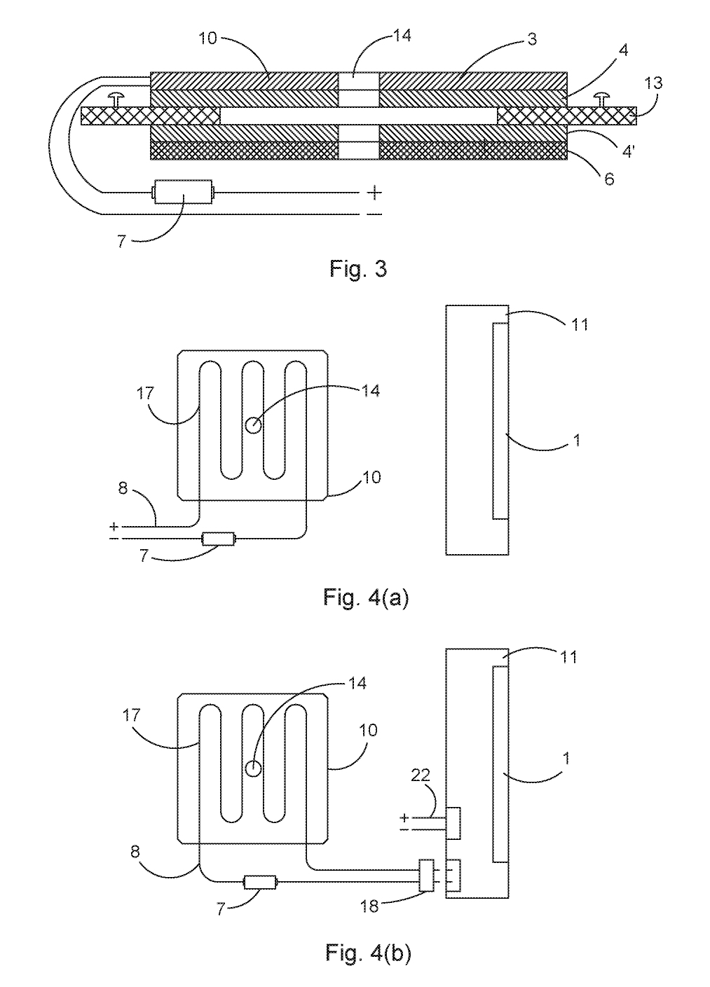

Referring now to the invention in more detail, in FIG. 3 there is shown a cross section of the side view of the flat electrical junction box cover 13 and the removable flexible heater 10. The heating blanket 3 and insulation means 6 are placed from the opposite sides of the electrical junction box cover 13 and attached to said box cover 13 by the holding means 4 and 4′. The flexible heater 10 is placed on the front side of the junction box cover 13 to maximize heat exchange between the heater 10 and electronic device to be warmed. It is preferable to use this construction when electrical junction box cover 13 is made of materials having low thermal conductivity such as polymers.

In further detail, in FIG. 3 there is shown a freeze protection temperature control means 7 which controls the temperature and electrically energizes the flexible heater 10 when the ambient temperature falls below 5° C. (41° F.).

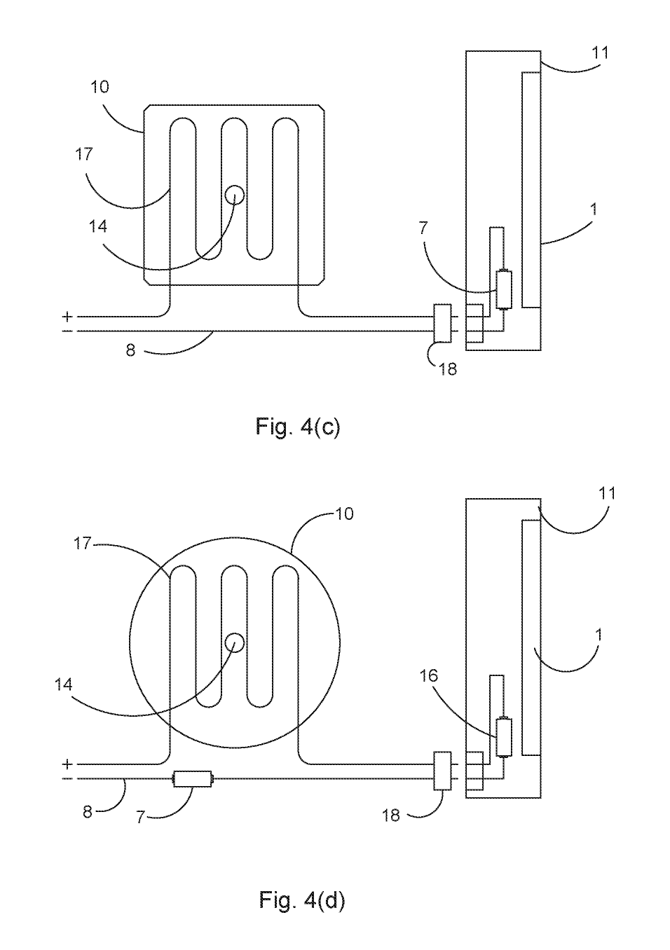

Referring now to the invention in more detail, in FIG. 4(a) there is shown a schematic of electrical connection of the flexible heater 10, having heating element 17. Said heating element 17 is electrically connected to the temperature control means 7 which is separated from the heater 10 by lead wires 8 to allow control of the ambient temperature. The heater 10 and the flat panel display device 11 are not electrically interconnected. The heater 10 has an independent electrical power supply from the flat panel display device 11. This construction and assembly method allows combining of the removable heater with the flat panel display device in the field without interfering with the electrical connection and assembly of the flat panel display device.

Referring now to the invention in more detail, in FIG. 4(b) there is shown an alternative schematic of electrical connection of the flexible heater 10 with temperature control means 7 which are electrically connected and energized through the electrical connector 18 and power source 22 of the flat panel display device 11. This alternative construction and assembly method allow the utilization of the same power supply source 22 (for example single low voltage stepdown transformer) for both, the flexible heater 10 and flat panel display device 11.

Referring now to the invention in more detail, in FIG. 4(c) there is shown an alternative schematic of electrical connection of the heating elements 17 inside the flexible heater 10 and flat panel display device 11. The freeze protection temperature control means 7 in this embodiment of the invention is placed inside of the flat panel display device 11.

Referring now to the invention in more detail, in FIG. 4(d) there is shown an alternative schematic of electrical connection of the heating elements 17 inside of the heater 10. The heating elements 17 are electrically connected to at least two temperature control devices through the electrical connector 18. The temperature control means 7 electrically energizes the heater 10, when the ambient temperature falls below 5° C. The overheat protection means 16 is placed inside of the flat panel display device 11 and protects the flat panel display 1 from overheating. It is preferable that the overheat protection means 16 terminates electrical continuity in the flexible heater 10 when the temperature inside the flat panel display device 11 rises above 32° C. This alternative construction and assembly method allows to provide the most controlled thermal performance of the flat panel display device 11 protecting it from freezing, misting and overheating. It is possible to use either separate power supply or shared power supply between the heater 10 and flat panel display device 11.

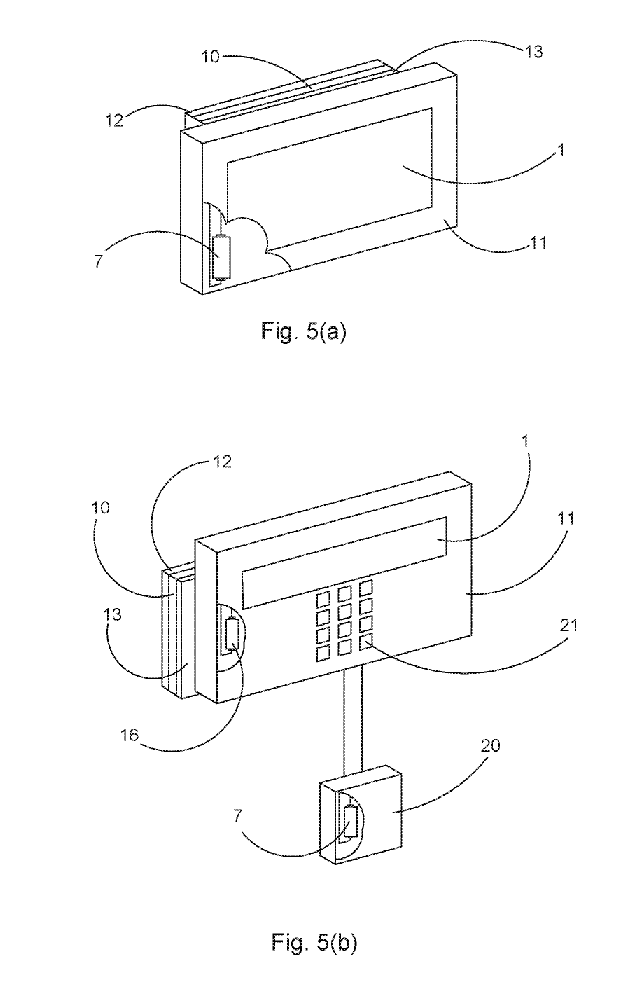

Referring now to the invention in more details, in FIG. 5(a) there is shown an example of a flat panel display device 11 (for example touchscreen entrance keypad) with the removable heater 10 attached to the back of device 11. The freeze protection temperature control means 7 is placed inside of the device 11.

Referring now to the invention in more details, in FIG. 5(b) there is shown an example of a flat panel display device 11 (for example, LCD door entrance keypad) with the removable flexible heater 10, attached in front of the wall junction box assembly means 12 and behind the electrical junction box cover 13. The freeze protection temperature control means 7 is placed on the wall below the device 11 and electrically connected to the removable heater 10 to measure the ambient temperature. The temperature control means 7 activates and electrically energizes the heater 10 when the ambient temperature falls below 5° C. (41° F.). It is preferable to place the temperature control means 7 in a protection cover 20 to avoid accidental mechanical damage of temperature control means 7.

In further detail, in FIG. 5(b) there is shown an internal overheat protection means 16 which disconnects electrical power in the removable heater 10 when the temperature elevates to 32° C. (90° F.) near the flat panel electronic display 1 and pushbutton keypad 21.

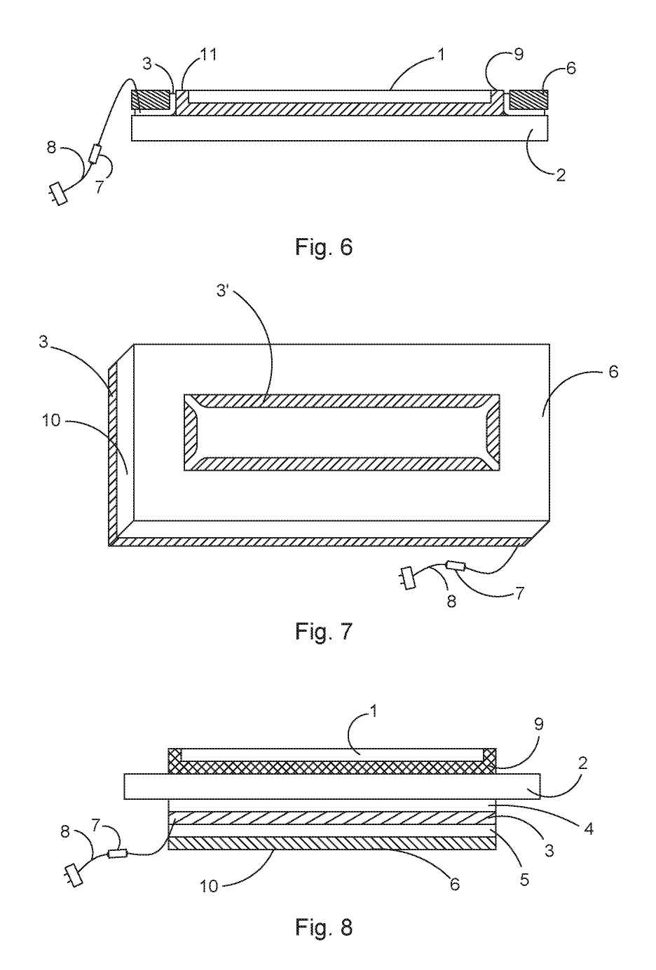

Referring now to the invention in more detail, in FIG. 6 there is shown a flat panel display device 11 that has the flat panel electronic display 1 (for example, LCD or LED) and enclosure 9, which is attached to PCB 2 and has a flexible heating blanket 3 with insulation means 6.

In more detail, still referring to FIG. 6 the flexible heating blanket 3 is placed inside of the electronic display device on the perimeter of the enclosure 9 and on PCB2, and has optional holding means 4, for example adhesive.

In further detail, still referring to FIG. 6, the flexible heating blanket 3 is connected to a temperature control device 7 through lead wires 8. The temperature control device 7 allows to electrically energize the flexible heating blanket 3 at the ambient temperatures below 5° C.

The construction details of the invention as shown in FIG. 6 are that the heating blanket 3 with insulation 6 are placed on the perimeter of the enclosure means 9, it can be installed or removed in the field after enclosure 9 is attached to PCB 2. The flexible heating blanket 3 can be made from the flexible heating elements laminated between fabrics or films to allow folding of the heating blanket 3 to fit the perimeter of the enclosure 9 and to be in direct contact with enclosure 9.

Referring now to the invention in more detail, the removable flexible heater 10 is described separately in FIG. 7 showing the flexible heating blanket 3, insulation means 6 and temperature control means 7. The flexible heating blanket portion 3′ folds and wraps around the external perimeter side of the flat panel electronic display at the time of fitting the flexible heater 10 around it.

The alternative embodiment of the current invention is described in FIG. 8 where the flexible heater 10 is placed directly behind the Printed Circuit Board (PCB) 2 and covers the back surface of flat panel electronic display from at least one side of the enclosure means 9. The Insulation means 6 including the optional heat reflection layer 5 are placed behind the heating blanket 3. The heating blanket 3 is attached to PCB 2 by the optional holding means 4, for example adhesive. The freeze protection of the flat panel display 1 is provided by heating the enclosure means 9 and PCB 2 from the back.

The advantage of the current invention is the use of the external flexible heater on the back or on the side perimeter of the flat panel electronic display which prevents obstruction of the front of the display (like LCD or LED) and eliminates uncontrolled heat dissipation. Such placement of the heater assembly of the present invention also allows removability of the heater assembly, quick and easy placement of the heater during its field installation and use of the thick insulation to maximize energy efficiency and freeze protection of the flat panel displays.

In broad embodiment, the invention is the flexible heater which can be placed on the perimeter or behind the flat panel display of the access control security systems, key entrance pads, TV sets of RV's, or other outdoor devices which require freeze protection in cold ambient temperatures.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. An electrical flexible heater for freeze protection of electronic display means, said heater comprising:
an electrical heating blanket positioned at least behind of said electronic display means;
an insulating means said insulating means reflects heat, generated by said heating blanket, towards said electronic display means;
a freeze protection temperature control means, said control means triggers electrical continuity in said heating blanket at ambient temperatures below 5° C.

2. The electrical heater according to claim 1 wherein said freeze protection temperature control means is electrically connected to and distanced away from said heating blanket.

3. The heater according to claim 2 wherein said freeze protection temperature control means is positioned inside of said electronic display means.

4. The heater according to claim 1 further comprising overheat protection means positioned inside of said electronic display means, said overheat protection means terminates electrical continuity of said heating blanket at the temperatures above 32° C.

5. The heater according to claim 1 wherein said electrical heating blanket is positioned inside of an electrical junction box assembly means.

6. The heater according to claim 1 wherein said electrical heating blanket is attached to a removable electrical junction box cover.

7. The heater according to claim 1 wherein said electrical heating blanket comprises at least one conductor opening means for electrical wiring access to said electronic display means.

8. The heater according to claim 1 wherein said electrical heating blanket is further attached around perimeter of said electronic display means.

9. A method for warming and freeze protection of electronic display means, said method comprising:
attaching of removable electrical flexible heater, comprising electrical heating blanket, insulation means and freeze protection temperature control means,
behind of said electronic display means,
energizing of said heating blanket by electrical current when the temperature of said temperature control means falls below 5° C.

10. The method for warming and freeze protection of electronic display means as defined in claim 9, wherein said freeze protection temperature control means is distanced away from said flexible heating blanket and said electronic display.

11. The method for warming and freeze protection of electronic display means as defined in claim 9, further attaching of said freeze protection temperature control means inside of said electronic display means.

12. The method for warming and freeze protection of electronic display means as defined in claim 9, further attaching of overheat protection means inside of said electronic display means, said overheat protection means terminates electrical continuity in said flexible heater at the temperature above 32° C.

13. The method for warming and freeze protection of electronic display means as defined in claim 9, further attaching of said flexible heating blanket and said insulation means to a removable electrical junction box cover.

14. The method for warming and freeze protection of electronic display means as defined in claim 9, further attaching of said flexible electrical heating blanket around the perimeter of said electronic display.

15. An electrical flexible heater for freeze protection of electronic display device, said heater comprising:
an electrical heating blanket adapted to be positioned at least behind of said electronic display device;
an insulation member, said insulation member reflects heat, generated by said heating blanket, towards said electronic display device;
a freeze protection temperature control apparatus, said control apparatus triggers electrical continuity in said heating blanket at ambient temperatures below 5° C.

16. The electrical heater according to claim 15 wherein said freeze protection temperature control apparatus is electrically connected to and distanced away from said heating blanket.

17. The heater according to claim 16 wherein said freeze protection temperature control apparatus is positioned inside of said electronic display device.

18. The heater according to claim 15 further comprising overheat protection mechanism positioned inside of said electronic display device, said overheat protection mechanism terminates electrical continuity of said heating blanket at the temperatures above 32° C.

19. The heater according to claim 15 wherein said electrical heating blanket is positioned inside of an electrical junction box assembly.

20. The heater according to claim 15 wherein said electrical heating blanket is attached to a removable electrical junction box cover.
